(19) United States
(12) Patent Application Publication
(10) Pub. No.: US 2007/0174317 A1
(43) Pub. Date: Jul. 26, 2007

(54) System and method for modifying the structure and content of dissimilar databases

(75) Inventors: Matthew J. Bangel, Poughkeepsie, NY (US); James A. Martin JR., Endicott, NY (US); Douglas G. Murray, Johnson City, NY (US)

Correspondence Address: SHELLEY M. BECKSTRAND;PATENT ATTORNEY, 61 GLENMONT ROAD, WOODLAWN, VA, 24381, US

(73) Assignee: International Business Machines Corporation, Armonk, NY (US)

(21) Appl. No.: 11/340,307

(22) Filed: Jan. 26, 2006

(51) Int. Cl. G06F 7/00

(52) U.S. Cl. 707/101

(57) ABSTRACT

The schema of a database may be modified by selectively entering original data to an original database having an original schema; opening the original schema in a user interface; operating the user interface to make changes to the original schema; responsive to the changes being saved, creating a new schema with the changes, creating a backup table with the original schema and copying original data entered to the original database to the backup table, testing the original data with respect to the new schema to identify cases requiring modification of the data to conform to the new schema; and copying the original data as selectively modified from the backup table to the a new database having the new schema.

### BACKGROUND OF THE INVENTION

1. Technical Field of the Invention

This invention relates to computer databases. More particularly, it relates to modifying the database schema of a database previously populated with data.

2. Background Art

In database logic it should be impossible for an existing table or view to be edited once data has been entered into the database.

It is possible, using a query language, to create new views on an existing database, to look at the data in the database in a new way, and to extract the data from such a database into a new view which organizes the data differently at the user interface. However, adding such views into a database design does not change a database table after it has been populated with data. Heretofore it has not been possible, due the storage method, to change a database table, as distinguished from views on such a table, without completely dumping the data itself.

Thus, it is a characteristic of database designs to lock a user away from performing such modifications of the structure of the database once a database table, view, or other design element is created. This presents the problem that, if for any reason a developer were to make a human mistake as he or she is completing table creation, even a small one, the only option available is to delete the table schema and begin again. This is the case for any mistake, including misspelling a column name, using an incorrect data type, and so forth.

In a specific example, a relational database, such as the IBM DB2 database table editor, has several design characteristics of interest to the present invention. Among these are that the table editor is localized completely to DB2 databases, using only DB2 protocols to access DB2 database elements.

In general, every database product of the prior art when written may have been based on similar or same concepts but were designed with a unique application programming interface (API). The result is, for example, when trying to access a set of data from an Oracle database, the user will be required to use a different query from that used to access a MySQL database or DB2 database. There is, therefore, a need in the art to provide the ability to access multiple databases off multiple servers having a variety of different data source types.

A database typically includes a table with columns and rows of data. There is a need in the art for an interface that allows a user to visualize each column, and to correct problems identified by changing the properties of selected columns. There is also a need in the art for the ability to repopulate a database having an altered schema or structure with data from an original database.

There is, therefore, a need in the art for a fully generic solution which provides a generic interface into a plurality of disparate databases, which provides a visual interface into each schema item, and which provides automatic data propagation from an old schema to a new schema.

### SUMMARY OF THE INVENTION

A system, method, and program product for modifying the schema of a database by selectively entering original data to an original database having an original schema; opening the original schema in a user interface; operating the user interface to make changes to the original schema; responsive to the changes being saved, creating a new schema with the changes, creating a backup table with the original schema and copying original data entered to the original database to the backup table, testing the original data with respect to the new schema to identify cases requiring modification of the data to conform to the new schema; and copying the original data as selectively modified from the backup table to the a new database having the new schema.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a high level schematic representation of a system in accordance with the invention.

FIG. 2 is a high level schematic representation of a schema (Table 1).

FIG. 3 is a high level schematic representation of visual interface 52 of FIG. 1.

FIG. 4 is a flow chart representation of a process for creating a database having a new schema and including data from a prior database.

FIG. 5 is a flow chart representation of steps executed when copying data from a backup database into a new database having a new schema.

### DETAILED DESCRIPTION OF PREFERRED EMBODIMENTS

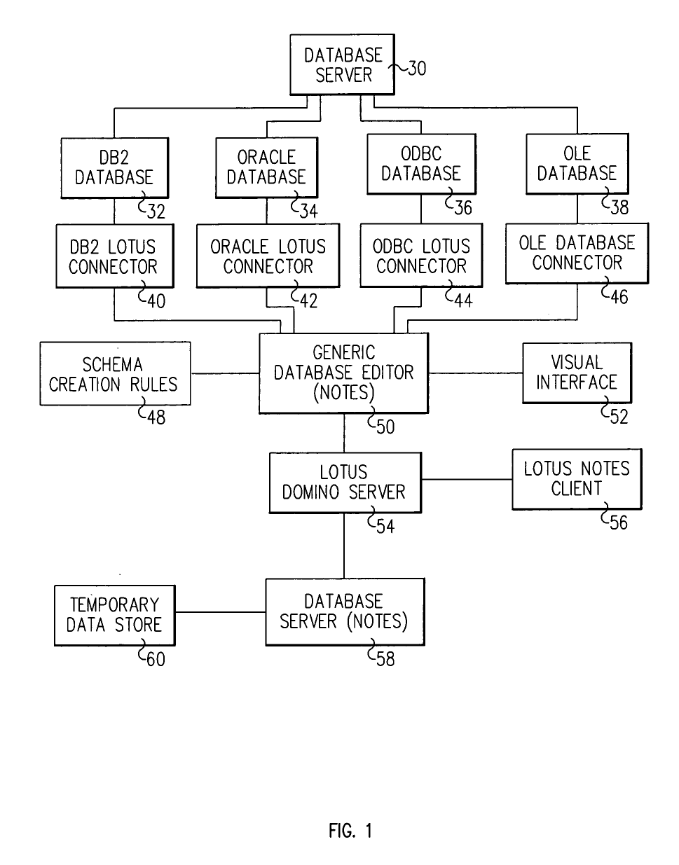

Referring to FIG. 1, in accordance with the present invention there is provided a generic interface into database schema independent of product specific coding or interfaces by overlapping the generic interface on top of all types of database products. This provides the ability to modify table and view design without purging existing data from the table for good.

Generic interface, or API, 52 is provided into multiple databases 32, 34, 36, 38, including a visual interface into each schema item, and a generic database editor 50 for automatic data propagation from an old schema to a new schema in accordance with schema creation rules 48. Interface 52 is a tool or application for designing databases which allows, in combination with a connector 40, 42, 44, 46, changes to all relational databases. These connectors provide a translation between the generic API 52 and the relational database API 52. This provides a common API for changing all databases 32, 34, 36, and 38 for which a connector 40, 42, 44, 46 is provided.

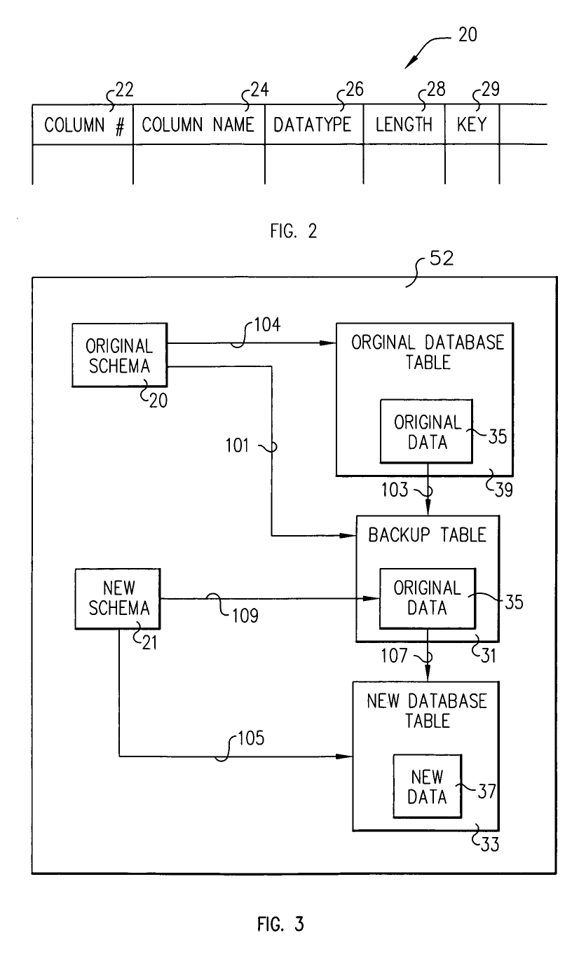

Referring to FIG. 2, for example, such an interface 52 may provide a view (Table 1) into a Notes database including a schema 20 having schema items COLUMN# 22, COLUMNNAME 24, DATATYPE 26, LENGTH 28, AND KEY 29.

TABLE 1
VIEW

| Column# | ColumnName | DataType | Length | Key |
|---|---|---|---|---|
| 1 | Division | Number | 2 | Y |
| 2 | Department | Text | Variable | Y |
| 3 | EmpCount | Number | Long | N |
| 4 | Rep | Text | 15 | N |

As will be more fully described hereafter, there is a difference between taking data out of a database 32 to view, and putting data into a database 32 which has had its schema altered. In accordance with the present invention, the schema is being altered, and data is not being used until the schema revision is completed and data is to be re-integrated into the new schema. However, this statement depends upon definitions of ‘schema’ and ‘data’. Consequently, for the purpose of this specification, ‘data’ is used to refer to information placed inside a table, and ‘schema’ is used to refer to the design of the table.

In accordance with an exemplary embodiment of the invention, using generic calls provided in several classes of the IBM Lotus Domino enterprise connectivity services (DECS) libraries, database schema is queried, modified, and deleted within those databases 32, 34, 36 that have a predefined Lotus connector 40, 42, 44. These databases types include the IBM DB2, Oracle, and Open Database Connectivity (ODBC). These classes include those contained in the “*lsxlc” Notes library, including LCConnection, LCFiledList, and LCField.

Open Database Connectivity (ODBC)and the SQL language are used in an exemplary embodiment to perform the methods of the present invention.

Referring to FIG. 1, a database modification system configuration includes a database server 30 for managing one or more databases, such as DB2 database 32, Oracle database 34, ODBC database 36, and OLE database 38. A connector 40, 42, 44, 46 is provided for each respective database to a generic database editor 50. Editor 50 implements schema creation rules 48 and provides a visual interface 52 for user input to a Lotus Domino server 54, Lotus Notes client 56, and Notes database server 58. Database server 58 has a temporary data store 60.

In operation, Lotus Notes 50 provides a visual interface 52 into each schema 20 item 22, 24, 26, 28, 29 in its Domino Designer Client 56 when editing views 20 in a Lotus Notes Database 60. In accordance with an exemplary embodiment of the invention, a Lotus Notes Database shell (not shown) is provided for the Designer Client 56.

With respect to ODBC, current applications in the art are designed for a specific database package (for example, DB2, Oracle, etc.). The present invention is configured as a third party application capable of servicing them all.

It is a further characteristic of the present invention that database modifications are made in a live data environment. That is, current data in, for example a DB2 database 32 is not lost when a schema 20 modification is performed; it is instead stored in temporary data store 60, modified, and re-integrated into the new system (database 32) automatically through very little user interaction.

Further in accordance with an exemplary embodiment of the invention, normal database protocols such as the OBDC and SQL languages are adhered to and worked around without end-user awareness through the use of a shell, or user interface 52. Such a shell allows the end user a simple way to change database schema 20, providing to a user the opportunity to change, for example, the data type 26 of a column 24. This cannot be done directly in SQL, but rather a full “CREATE TABLE” command is required to be fed to the server to re-create the table or view by such a command as the following example:
CREATE TABLE t (c CHAR(20) CHARACTER SET utf0 COLLATE utf8_bin;

However, by the present invention, a user may open a schema 20 and begin editing it.

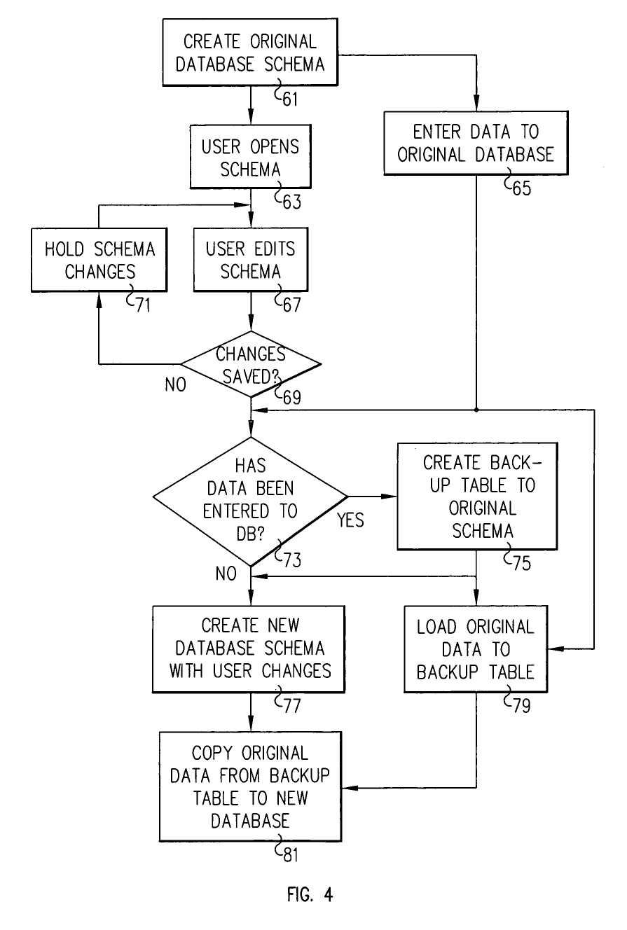

Referring to FIG. 4 in connection with FIG. 1 and FIG. 3, in step 61, as is represented by line 104, an original schema 20 is created for database 39 and in step 65, optionally, database 39 is populated with data 35 in accordance with schema 20. Database 39 may be any of database types 32, 34, 36, 38.

In step 63, a user opens schema 20 for the purpose of editing it in step 67. As is represented by line 102, in steps 69 and 71, changes to the schema 20 are held until a change is saved, whereupon in step 77 a new database schema 21 is created with the user changes (whether or not data has been loaded in step 65 to the original database, or table, 39). At step 73, if data exists within the table 39 being changed, in step 75, as is represented by line 101, a backup table 62 is created to the original schema 20 and in step 79 as is represented by line 103, the original data 35 from database 39 (step 65) is loaded to the backup table 31 in temporary data store 60. Then, in step 77, a new database schema 21 corresponding to the user's changes is created and in step 81, as is represented by line 107, the old data is copied back from the backup table 31 into a new table 33, or container, structured, as is represented by line 105, according to the new schema 21.

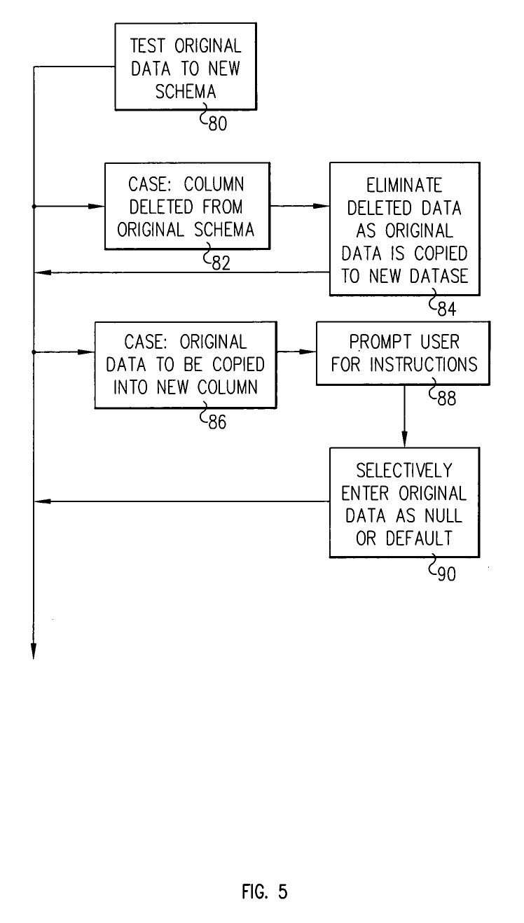

Referring to FIG. 5, during the copy back process of step 81, in step 80, as is represented by line 109, the original data 35 is tested against the new schema 21, and data 35 modified into new data 37 as required to conform to the new schema 21. This includes, for example, for a case 82, deleting in step 84 data from deleted columns 24, and for a case 86, prompting the user in step 88 for instruction on how to reintroduce old data 35 as new data 37 into new columns 24, such as by giving that data default or NULL value in step 90. Other cases may include, for example, converting datatype 26 from integer to decimal.

Old data 35 will be reintroduced with a null or default value due to changes 102 made in the schema 20. If a column 24 is added for example when an old data 35 row is loaded back as new data 37 according to new schema 21 it is not going to have data specific to that new column 20. It is easier when columns 20 are deleted because the data 35 is simply lost, but for adding new columns 20, the null or default value is needed to handle them.

In accordance with an aspect of the invention, a schema editor is provided into multiple database types through an Open Database Connectivity Connection. In this way, the design of dissimilar databases may be edited in one place, while enabling any old data to be stored and re-integrated back into the newly modified design of any particular database. Thus, while old database 39 and backup table 35 may be any of database types 32, 34, 36, 38, new table may be any of database types 32, 34, 36, 38, and need not be of the same type as old database 39.

### ADVANTAGES OVER THE PRIOR ART

It is an advantage of the invention that there is provided an improved system and method for modifying the schema of a database.

### ALTERNATIVE EMBODIMENTS

It will be appreciated that, although specific embodiments of the invention have been described herein for purposes of illustration, various modifications may be made without departing from the spirit and scope of the invention.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution, system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays,. pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a fe of the currently available types of network adapters.

Accordingly, the scope of protection of this invention is limited only by the following claims and their equivalents.

We claim:

1. A method for modifying the schema of a database, comprising:
selectively entering original data to an original database having an original schema;
opening said original schema in a user interface;
operating said user interface to make changes to said original schema;
responsive to said changes being saved,
creating a new schema with said changes;
creating a backup table with said original schema and copying original data entered to said original database to said backup table;
testing said original data with respect to said new schema to identify cases requiring modification of said data to conform to said new schema; and
copying said original data as selectively modified from said backup table to said a new database having said new schema.

2. The method of claim 1, further comprising:
responsive to determining that said new schema deletes a column from said original schema, eliminating deleted data as original data is copied from said backup table to said new database.

3. The method of claim 1, further comprising:
responsive to determining that original data is to be copied into a new column of said new schema, prompting said user for conversion instructions, said conversion instructions selectively being to enter original data in said new database as a default value.

4. A system for modifying the schema of a database without purging for good data previously stored to said database, comprising:
a first database for storing original data in accordance with a first schema;
a backup table;
a second database for storing modified data in accordance with a second schema;
a visual interface for displaying to a user said first schema and responsive to user input for entering changes to said first schema;
an editor responsive to said changes being saved for creating said second schema with said changes;
creating said backup table with said original schema and copying said original data from said first database to said backup table;
testing said original data with respect to said second schema to identify cases requiring modification of said original data to conform to said second schema; and
copying said original data as selectively modified from said backup table to said second database.

5. A computer program product for modifying the schema of a database, said computer program product comprising:
a computer readable medium; first program instructions for selectively entering original data to an original database having an original schema;
second program instructions for opening said original schema in a user interface;
third program instructions for operating said user interface to make changes to said original schema;
responsive to said changes being saved,
fourth program instructions for creating a new schema with said changes;
fifth program instructions for creating a backup table with said original schema and copying original data entered to said original database to said backup table;
sixth program instructions for testing said original data with respect to said new schema to identify cases requiring modification of said data to conform to said new schema; and
seventh program instructions for copying said original data as selectively modified from said backup table to said a new database having said new schema; and wherein.
said first, second, third, fourth, fifth, sixth, and seventh program instructions are recorded on said medium.

6. The computer program product of claim 5, further comprising eighth program instructions responsive to determining that said new schema deletes a column from said original schema for eliminating deleted data as original data is copied from said backup table to said new database, and wherein said eighth program instructions are recorded on said medium.

7. The computer program product of claim 5, further comprising eighth program instructions responsive to determining that original data is to be copied into a new column of said new schema, prompting said user for conversion instructions, said conversion instructions selectively being to enter original data in said new database as a default value, and wherein said eighth program instructions are recorded on said medium.

8. The computer program product of claim 5 wherein said original database and said new database are of dissimilar database types.

9. The method of claim 1 wherein said original database and said new database are of dissimilar database types.

10. The system of claim 4 wherein said first and second databases are of dissimilar database types.
